(19) United States
(12) Patent Application Publication
(10) Pub. No.: US 2026/0064272 A1
(43) Pub. Date: Mar. 5, 2026

(54) STORAGE DEVICE FOR COMPRESSING AND STORING PLURALITY OF INPUTTED DATA UNITS, AND METHOD FOR OPERATING THE SAME

(71) Applicant: SK hynix Inc., Icheon-si (KR)

(72) Inventor: Soo Jin KIM, Icheon-si (KR)

(21) Appl. No.: 19/020,236

(22) Filed: Jan. 14, 2025

(30) Foreign Application Priority Data
Aug. 28, 2024 (KR) 10-2024-0116068

(51) Int. Cl. G06F 3/06

(52) U.S. Cl. CPC G06F 3/0608; G06F 3/0655; G06F 3/0679

(57) ABSTRACT

A storage device may include a memory and a controller. The controller may compress a plurality of data units inputted from a host into a plurality of compressed data units, and may store the plurality of compressed data units in the memory. The controller may determine a first compression algorithm among a plurality of candidate compression algorithms on the basis of a start data unit which is inputted first among the plurality of data units, may compress N number of first data units, which are inputted first among the plurality of data units, into M number of first compressed data units using the first compression algorithm, and may store the M number of first compressed data units in the memory.

### CROSS-REFERENCE TO RELATED APPLICATION

The present application claims priority under 35 U.S.C. § 119 (a) to Korean Patent Application No. 10-2024-0116068 filed in the Korean Intellectual Property Office on Aug. 28, 2024, which is incorporated herein by reference in its entirety.

### BACKGROUND

### 1. Technical Field

Embodiments of the present disclosure generally relate to a storage device that compresses and stores a plurality of input data units, and a method for operating the same.

### 2. Related Art

A storage device is a device for storing data according to a request from an external device such as a computer, a mobile terminal (e.g., a smart phone or tablet), or the like.

A storage device may include a memory for storing data therein and a controller for controlling the memory. The memory may be a volatile memory or a non-volatile memory. The controller may receive a command from an external device (i.e., a host), and execute or control operations to read, write, or erase data in the memory included in the storage device according to the received command.

In order to support technologies such as artificial intelligence (AI), machine learning (ML), natural language processing (NLP), large language model (LLM), etc., a storage device capable of storing a large amount of data is required. A storage device may compress data and store compressed data to increase data storage efficiency.

### SUMMARY

Various embodiments of the present disclosure are directed to providing a storage device which selectively applies a compression algorithm to each of parts of data, thereby being capable of increasing the compression ratio of the entire data to efficiently store a large amount of data, and a method for operating the same.

In an aspect, a storage device may include: a memory; and a controller configured to compress a plurality of data units, input from a host, into a plurality of compressed data units and to store the plurality of compressed data units in the memory. The controller may select a first compression algorithm among a plurality of candidate compression algorithms using a start data unit, which is input first among the plurality of data units, may compress an N (N is a natural number) number of first data units, which are input first among the plurality of data units, into an M (M is a natural number equal to or smaller than N) number of first compressed data units using the first compression algorithm, and may store the M number of first compressed data units in the memory.

In another aspect, a method for operating a storage device may include: determining a first compression algorithm among a plurality of candidate compression algorithms on the basis of a start data unit, which is inputted first among a plurality of data units inputted from a host; compressing N (N is a natural number) number of first data units, which are inputted first among the plurality of data units, into M (M is a natural number equal to or smaller than N) number of first compressed data units using the first compression algorithm; and storing the M number of first compressed data units in a memory.

In still another aspect, a storage device may include: a memory; and a controller configured to compress a plurality of data units input from a host into a plurality of compressed data units using at least one of a plurality of candidate compression algorithms, and to store the plurality of compressed data units in the memory. An M (M is a natural number) number of first compressed data units among the plurality of compressed data units may be compressed using a first compression algorithm among the plurality of candidate compression algorithms, an N (N is a natural number) number of second compressed data units among the plurality of compressed data units may be compressed using a second compression algorithm among the plurality of candidate compression algorithms.

According to the embodiments of the present disclosure, by selectively applying a compression algorithm to each of parts of data, the compression ratio of the entire data may be increased to efficiently store a large amount of data.

### BRIEF DESCRIPTION OF THE DRAWINGS

FIG. 1 is a schematic configuration diagram of a storage device according to an embodiment of the present disclosure.

FIG. 2 is a block diagram schematically illustrating a memory of FIG. 1.

FIG. 3 is a schematic diagram illustrating an operation of a storage device according to embodiments of the present disclosure.

FIG. 4 is a diagram illustrating an operation in which a storage device compresses an N number of first data units according to embodiments of the present disclosure.

FIG. 5 is a flowchart illustrating an operation in which a storage device determines a first compression algorithm according to embodiments of the present disclosure.

FIG. 6 is a diagram illustrating reference information used by a storage device to arrange the plurality of candidate compression algorithms according to the embodiments of the present disclosure.

FIG. 7 is a diagram illustrating an operation in which a storage device compresses a K number of second data units DU_2 according to the embodiments of the present disclosure compresses K number of second data units.

FIG. 8 is a diagram illustrating an operation in which a storage device stores compression algorithm information in a memory according to the embodiments of the present disclosure.

FIG. 9 is a diagram illustrating an operation in which a storage device stores compression algorithm information in a mapping table according to the embodiments of the present disclosure.

FIG. 10 is a diagram illustrating a method for operating a storage device according to embodiments of the present disclosure.

### DETAILED DESCRIPTION

Hereinafter, embodiments of the present disclosure are described in detail with reference to the accompanying drawings. Throughout the specification, reference to “an embodiment,” “another embodiment” or the like is not necessarily referring to only one embodiment, and different references to such phrases are not necessarily limited to the same embodiment(s). The term “embodiments” when used herein does not necessarily refer to all embodiments within the scope of the disclosure.

Various embodiments of the present disclosure are described below in more detail with reference to the accompanying drawings. However, the present disclosure may be embodied in different forms and variations, and should not be construed as being limited to the embodiments set forth herein. Rather, the described embodiments are provided so that this disclosure will be thorough and complete, and will fully convey the present disclosure to those skilled in the art to which this disclosure pertains. Throughout the disclosure, like reference numerals refer to like parts throughout the various figures and embodiments of the present disclosure.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, logic, interfaces, decoders, drivers, generators and other signal generating and signal processing features may include, for example, a memory or other storage device for storing code or instructions to be executed, for example, by a computer, processor, microprocessor, controller, or other signal processing device.

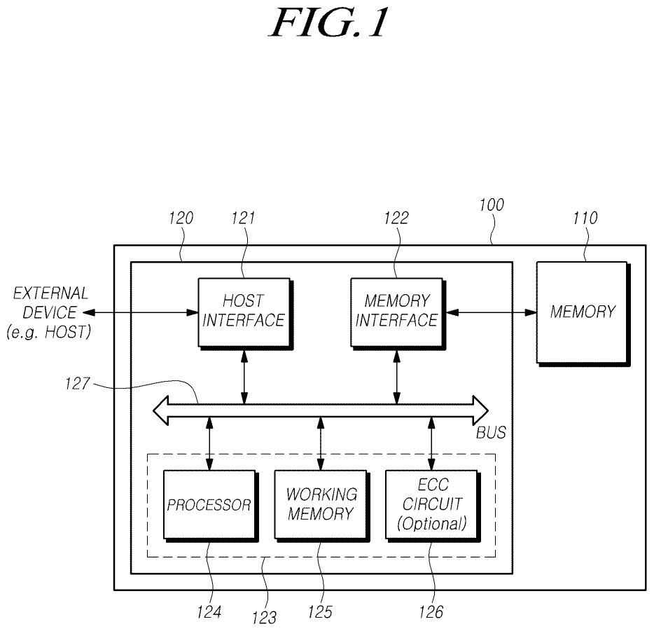

FIG. 1 is a schematic configuration diagram of a storage device according to an embodiment of the disclosure.

Referring to FIG. 1, a storage device 100 may include a memory 110 that stores data and a controller 120 that controls the memory 110.

The memory 110 includes a plurality of memory blocks, and operates in response to the control of the controller 120. Operations of the memory 110 may include, for example, a read operation, a program operation (also referred to as a write operation) and an erase operation.

The memory 110 may include a memory cell array including a plurality of memory cells (also simply referred to as “cells”) that store data.

For example, the memory 110 may be realized in various types of memory such as a DDR SDRAM (double data rate synchronous dynamic random access memory), an LPDDR4 (low power double data rate 4) SDRAM, a GDDR (graphics double data rate) SDRAM, an LPDDR (low power DDR), an RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM) and a spin transfer torque random access memory (STT-RAM).

The memory 110 may be implemented as a three-dimensional array structure. For example, embodiments of the disclosure may be applied to a charge trap flash (CTF) in which a charge storage layer is configured by a dielectric layer and a flash memory in which a charge storage layer is configured by a conductive floating gate.

The memory 110 may receive a command and an address from the controller 120 and may access an area in the memory cell array that is selected by the address. In other words, the memory 110 may perform an operation indicated by the command, on the area selected by the address.

The memory 110 may perform a program operation, a read operation or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 may control write (program), read, erase and background operations for the memory 110. For example, background operations may include at least one from among a garbage collection (GC) operation, a wear leveling (WL) operation, a read reclaim (RR) operation, a bad block management (BBM) operation, and so forth.

The controller 120 may control the operation of the memory 110 according to a request from a device (e.g., a host) located outside the storage device 100. The controller 120, however, also may control the operation of the memory 110 regardless of a request of the host.

The host may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host may be a virtual reality (VR) device providing 2D or 3D virtual reality images or an augmented reality (AR) device providing augmented reality images. The host may be any one of various electronic devices that require the storage device 100 to be capable of storing data.

The host may include at least one operating system (OS). The operating system may generally manage and control the function and operation of the host, and may control interoperability between the host and the storage device 100. The operating system may be classified into a general operating system and a mobile operating system depending on the mobility of the host.

The controller 120 and the host may be devices that are separated from each other, or the controller 120 and the host may be integrated into one device. Hereunder, for the sake of convenience in explanation, descriptions will describe the controller 120 and the host as devices that are separated from each other.

Referring to FIG. 1, the controller 120 may include a memory interface 122 and a control circuit 123, and may further include a host interface 121.

The host interface 121 provides an interface for communication with the host. For example, the host interface 121 provides an interface that uses at least one from among various interface protocols such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, an IDE (integrated drive electronics) protocol and a private protocol.

When receiving a command from the host, the control circuit 123 may receive the command through the host interface 121, and may perform an operation of processing the received command.

The memory interface 122 may be coupled with the memory 110 to provide an interface for communication with the memory 110. That is to say, the memory interface 122 may be configured to provide an interface between the memory 110 and the controller 120 in response to the control of the control circuit 123.

The control circuit 123 performs the general control operations of the controller 120 to control the operation of the memory 110. To this end, for instance, the control circuit 123 may include at least one of a processor 124 and a working memory 125, and may optionally include an error detection and correction circuit (ECC circuit) 126.

The processor 124 may control general operations of the controller 120, and may perform a logic calculation. The processor 124 may communicate with the host through the host interface 121, and may communicate with the memory 110 through the memory interface 122.

The processor 124 may execute logical operations required to perform the function of a flash translation layer (FTL). The processor 124 may translate a logical block address (LBA), provided by the host, into a physical block address (PBA) through the flash translation layer. The flash translation layer may receive the logical block address and translate the logical block address into the physical block address, by using a mapping table.

There are various address mapping methods of the flash translation layer, depending on a mapping unit. Representative address mapping methods include a page mapping method, a block mapping method and a hybrid mapping method.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be outputted to the host.

The processor 124 may execute firmware to control the operation of the controller 120. Namely, in order to control the general operation of the controller 120 and perform a logic calculation, the processor 124 may execute (drive) firmware loaded in the working memory 125 upon booting.

Hereafter, an operation of the storage device 100 according to embodiments of the disclosure will be described as implementing a processor 124 that executes firmware in which the corresponding operation is defined.

Firmware, as a program to be executed in the storage device 100 to drive the storage device 100, may include various functional layers. For example, the firmware may include binary data in which codes for executing the functional layers, respectively, are defined.

For example, the firmware may include at least one from among a flash translation layer, which performs a translating function between a logical address requested to the storage device 100 from the host and a physical address of the memory 110; a host interface layer (HIL), which serves to analyze a command requested to the storage device 100 as a storage device from the host and transfer the command to the flash translation layer; and a flash interface layer (FIL), which transfers a command, instructed from the flash translation layer, to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logic calculation, which is defined in the firmware loaded in the working memory 125, to control the general operation of the controller 120. The processor 124 may store a result of performing the logic calculation defined in the firmware, in the working memory 125. The processor 124 may control the controller 120 according to a result of performing the logic calculation defined in the firmware such that the controller 120 generates a command or a signal. When a part of firmware, in which a logic calculation to be performed is defined, is stored in the memory 110, but not loaded in the working memory 125, the processor 124 may generate an event (e.g., an interrupt) for loading the corresponding part of the firmware into the working memory 125 from the memory 110.

The processor 124 may load metadata necessary for driving firmware from the memory 110. The metadata, as data for managing the memory 110, may include for example management information on user data stored in the memory 110.

Firmware may be updated while the storage device 100 is manufactured or while the storage device 100 is operating. The controller 120 may download new firmware from the outside of the storage device 100 and update existing firmware with the new firmware.

To drive the controller 120, the working memory 125 may store necessary firmware, a program code, a command and data. The working memory 125 may be a volatile memory that includes, for example, at least one from among an SRAM (static RAM), a DRAM (dynamic RAM) and an SDRAM (synchronous DRAM). Meanwhile, the controller 120 may additionally use a separate volatile memory (e.g. SRAM, DRAM) located outside the controller 120 in addition to the working memory 125.

The error detection and correction circuit 126 may detect an error bit of target data, and correct the detected error bit by using an error correction code. The target data may be, for example, data stored in the working memory 125 or data read from the memory 110.

The error detection and correction circuit 126 may decode data by using an error correction code. The error detection and correction circuit 126 may be realized by various code decoders. For example, a decoder that performs unsystematic code decoding or a decoder that performs systematic code decoding may be used.

For example, the error detection and correction circuit 126 may detect an error bit by the unit of a set sector in each of the read data, when each read data is constituted by a plurality of sectors. A sector may mean a data unit that is smaller than a page, which is the read unit of a flash memory. Sectors constituting each read data may be matched with one another using an address.

The error detection and correction circuit 126 may calculate a bit error rate (BER), and may determine whether an error is correctable or not, by sector units. For example, when a bit error rate is higher than a reference value, the error detection and correction circuit 126 may determine that a corresponding sector is uncorrectable or a fail. On the other hand, when a bit error rate is lower than the reference value, the error detection and correction circuit 126 may determine that a corresponding sector is correctable or a pass.

The error detection and correction circuit 126 may perform an error detection and correction operation sequentially for all read data. In the case where a sector included in read data is correctable, the error detection and correction circuit 126 may omit an error detection and correction operation for a corresponding sector for next read data. If the error detection and correction operation for all read data is ended in this way, then the error detection and correction circuit 126 may detect a sector that is uncorrectable in read data last. There may be one or more sectors that are determined to be uncorrectable. The error detection and correction circuit 126 may transfer information (e.g., address information) regarding a sector that is determined to be uncorrectable to the processor 124.

A bus 127 may be configured to provide channels among the components 121, 122, 124, 125 and 126 of the controller 120. The bus 127 may include, for example, a control bus for transferring various control signals, commands and the like, a data bus for transferring various data, and so forth.

Some components among the above-described components 121, 122, 124, 125 and 126 of the controller 120 may be omitted, or some components among the above-described components 121, 122, 124, 125 and 126 of the controller 120 may be integrated into one component. In addition to the above-described components 121, 122, 124, 125 and 126 of the controller 120, one or more other components may be added.

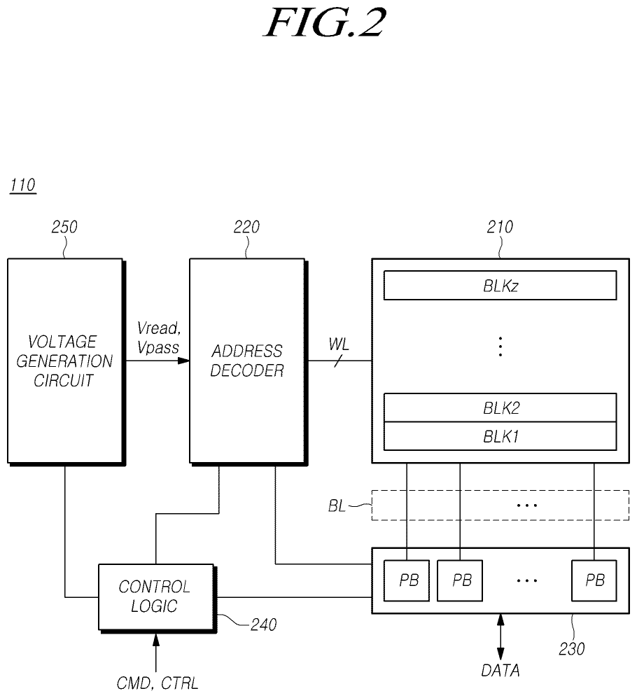

Hereinbelow, the memory 110 will be described in further detail with reference to FIG. 2.

FIG. 2 is a block diagram schematically illustrating a memory of FIG. 1.

Referring to FIG. 2, a memory 110 according to an embodiment of the disclosure may include a memory cell array 210, an address decoder 220, a read and write circuit 230, a control logic 240, and a voltage generation circuit 250.

The memory cell array 210 may include a plurality of memory blocks BLK1 to BLKz (where z is a natural number of 2 or greater).

In the plurality of memory blocks BLK1 to BLKz, a plurality of word lines WL and a plurality of bit lines BL may be disposed, and a plurality of memory cells may be arranged.

The plurality of memory blocks BLK1 to BLKz may be coupled with the address decoder 220 through the plurality of word lines WL. The plurality of memory blocks BLK1 to BLKz may be coupled with the read and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) that stores 1-bit data. In another instance, each of the plurality of memory cells included in the memory cell array 210 may be a multi-level cell (MLC) that stores 2-bit data. In still another instance, each of the plurality of memory cells included in the memory cell array 210 may be a triple level cell (TLC) that stores 3-bit data. In yet another instance, each of the plurality of memory cells included in the memory cell array 210 may be a quad level cell (QLC) that stores 4-bit data. In a further instance, the memory cell array 210 may include a plurality of memory cells, each of which stores 5 or more-bit data.

The number of bits of data stored in each of the plurality of memory cells may be dynamically determined. For example, a single-level cell that stores 1-bit data may be changed to a triple-level cell that stores 3-bit data.

Referring to FIG. 2, the address decoder 220, the read and write circuit 230, the control logic 240 and the voltage generation circuit 250 may operate as a peripheral circuit that drives the memory cell array 210.

The address decoder 220 may be coupled to the memory cell array 210 through the plurality of word lines WL.

The address decoder 220 may be configured to operate in response to the control of the control logic 240.

The address decoder 220 may receive an address through an input/output buffer in the memory 110. The address decoder 220 may be configured to decode a block address in the received address. The address decoder 220 may select at least one memory block depending on the decoded block address.

The address decoder 220 may receive a read voltage Vread and a pass voltage Vpass from the voltage generation circuit 250.

The address decoder 220 may apply the read voltage Vread to a selected word line WL in a selected memory block during a read operation, and may apply the pass voltage Vpass to the remaining unselected word lines WL.

The address decoder 220 may apply a verify voltage generated in the voltage generation circuit 250 to a selected word line WL in a selected memory block in a program verify operation, and may apply the pass voltage Vpass to the remaining unselected word lines WL.

The address decoder 220 may be configured to decode a column address in the received address. The address decoder 220 may transmit the decoded column address to the read and write circuit 230.

A read operation and a program operation of the memory 110 may be performed by the unit of a page. An address received when a read operation or a program operation is requested may include at least one from among a block address, a row address and a column address.

The address decoder 220 may select one memory block and one word line depending on a block address and a row address. A column address may be decoded by the address decoder 220 and be provided to the read and write circuit 230.

The address decoder 220 may include at least one from among a block decoder, a row decoder, a column decoder and an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that take charge of a data processing function, and may further include cache buffers that take charge of a caching function.

The plurality of page buffers PB may be coupled to the memory cell array 210 through the plurality of bit lines BL. The plurality of page buffers PB may continuously supply sensing current to bit lines BL coupled with memory cells to sense threshold voltages (Vth) of the memory cells in a read operation and a program verify operation, and may latch sensing data by sensing, through sensing nodes, changes in the amounts of current flowing, depending on the programmed states of the corresponding memory cells.

The read and write circuit 230 may operate in response to page buffer control signals outputted from the control logic 240.

In a read operation, the read and write circuit 230 temporarily stores read data by sensing data of memory cells, and then, outputs data DATA to the input/output buffer of the memory 110. As an exemplary embodiment, the read and write circuit 230 may include a column select circuit in addition to the page buffers PB or the page registers.

The control logic 240 may be coupled with the address decoder 220, the read and write circuit 230 and the voltage generation circuit 250. The control logic 240 may receive a command CMD and a control signal CTRL through the input/output buffer of the memory 110.

The control logic 240 may be configured to control general operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal outputted from the control logic 240.

Each memory block of the memory 110 described above may be configured by a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. In another example, each of the plurality of word lines WL may be disposed in a column direction, and each of the plurality of bit lines BL may be disposed in a row direction.

A memory cell may be coupled to one of the plurality of word lines WL and one of the plurality of bit lines BL. A transistor may be disposed in each memory cell.

For example, a transistor disposed in each memory cell may include a drain, a source, and a gate. The drain (or source) of the transistor may be coupled with a corresponding bit line BL directly or via another transistor. The source (or drain) of the transistor may be coupled with a source line (which may be the ground) directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line more adjacent to the read and write circuit 230 between two outermost word lines, and a second select line (also referred to as a drain select line or a source select line) may be additionally disposed outside a second outermost word line between the two outermost word lines.

At least one dummy word line may be additionally disposed between the first outermost word line and the first select line. At least one dummy word line may also be additionally disposed between the second outermost word line and the second select line.

A read operation and a program operation (write operation) of the memory block described above may be performed by the unit of a page, and an erase operation may be performed by the unit of a memory block.

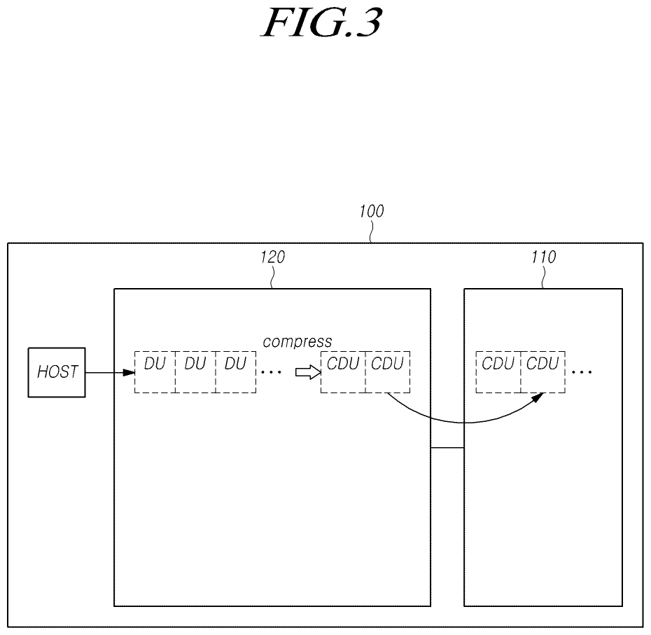

FIG. 3 is a schematic diagram illustrating an operation of a storage device according to embodiments of the present disclosure.

Referring to FIG. 3, a storage device 100 may include a memory 110 and a controller 120.

The controller 120 may compress a plurality of data units DU which are inputted from a host, into a plurality of compressed data units CDU.

The size of each of the plurality of data units DU may be a preset size. For example, the size of each data unit DU may be a multiple of the size (e.g., 4 KB) of a page included in the memory 110 or a multiple of the size of a memory block included in the memory 110.

The sum of the sizes of the plurality of compressed data units CDU may be smaller than the sum of the sizes of the plurality of data units DU.

The controller 120 may store the plurality of compressed data units CDU in the memory 110.

In the embodiments of the present disclosure, instead of compressing all of the plurality of inputted data units DU with the same compression algorithm, the controller 120 may selectively apply a compression algorithm to only a part of the plurality of data units DU.

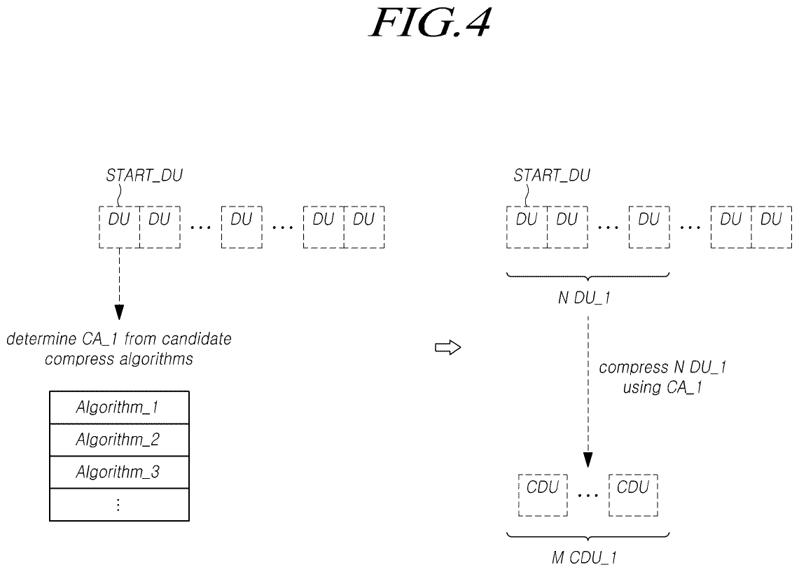

For example, a compression algorithm is used to compress N (where N is a natural number) number of data units DU input first from among the plurality of data units DU and a different compression algorithm is used to compress data units DU that are input subsequently. This will be described below in detail with reference to FIG. 4.

FIG. 4 is a diagram illustrating an operation in which a storage device compresses an N number of first data units according to embodiments of the present disclosure.

Referring to FIG. 4, by referring to a start data unit START_DU, which is the first input data from among the plurality of data units DU, a controller 120 of a storage device 100 may select a first compression algorithm CA_1 from among a plurality of preset candidate compression algorithms Algorithm_1, Algorithm_2, Algorithm_3, . . . .

The controller 120 may compress an N number of first data units DU_1, input first from among the plurality of data units DU, into an M (where M is a natural number equal to or smaller than N) number of first compressed data units CDU_1 using the first compression algorithm CA_1. The start data unit START_DU may be one of the N number of first data units DU_1.

The controller 120 may store the M number of first compressed data units CDU_1 in the memory 110.

If the controller 120 selects an optimal compression algorithm to apply to all of the data units DU, an advantageous compression ratio may increase. However, the time required to select an optimal compression algorithm for all of the data units DU may result in an overall decrease in compression speed.

Therefore, by searching for an optimal compression algorithm using only the start data unit START_DU, without using all of the data units DU, the controller 120 may select a compression algorithm more quickly. Accordingly, the controller 120 may increase compression speed for the plurality of data units DU.

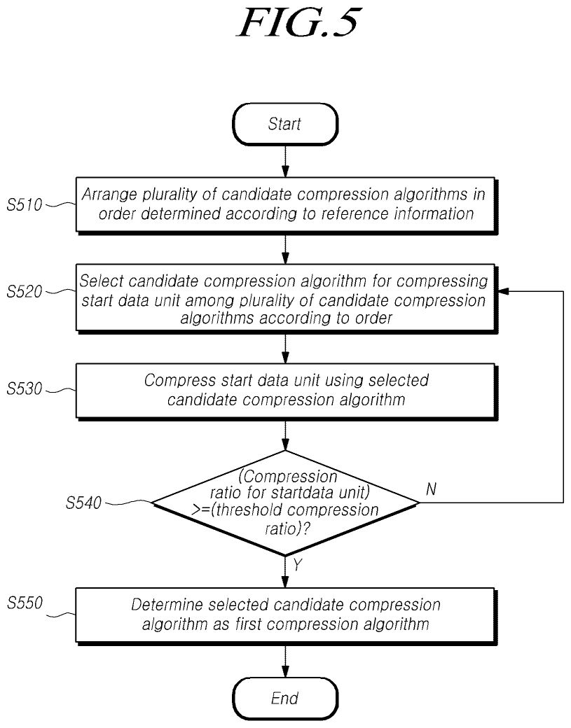

FIG. 5 is a flowchart illustrating an operation in which a storage device determines a first compression algorithm according to embodiments of the present disclosure.

Referring to FIG. 5, a controller 120 of a storage device 100 may arrange a plurality of candidate compression algorithms in an order determined according to preset reference information (S510).

That is to say, the controller 120 may determine an order in which a plurality of candidate compression algorithms will be selected in advance, before compressing any data. Since compression characteristics (e.g., compression ratios, compression times decompression times) of the plurality of candidate compression algorithms are determined independently of compressed data, the controller 120 may arrange the plurality of candidate compression algorithms without referring to data that is compressed using any of the plurality of candidate compression algorithms.

This preset reference information may be information stored in advance in the controller 120 or the memory 110, or the information may be received from a host.

The controller 120 may select a candidate compression algorithm, from among the plurality of candidate compression algorithms arranged in an above-described order, to compress the first data unit, which is the start data unit START_DU (S520).

The controller 120 may compress the start data unit START_DU using the selected candidate compression algorithm (S530).

When compressing the start data unit START_DU, a compression ratio for the start data unit START_DU may be calculated using the size of the start data unit START_DU and the size of compressed data, into which the start data unit is compressed.

The controller 120 determines whether the compression ratio for the start data unit START_DU is equal to or greater than a threshold compression ratio (S540).

When the compression ratio for the start data unit START_DU is equal to or greater than the threshold compression ratio (S540-Y), the controller 120 may determine that the candidate compression algorithm selected to compress start data unit START_DU is the first compression algorithm CA_1 (S550).

That is to say, when compression ratios for the start data unit START_DU are equal to or greater than a threshold compression ratio, the controller 120 may select a candidate compression algorithm with highest priority from among candidate compression algorithms, which may be the first compression algorithm CA_1 in the candidate compression algorithm list.

On the other hand, when the compression ratio for the start data unit START_DU is less than the threshold compression ratio (S540-N), the controller 120 may re-execute the step S520. In other words, the controller 120 may reselect a candidate compression algorithm for compressing the start data unit START_DU from among the plurality of candidate compression algorithms.

The controller 120 may reselect a candidate compression algorithm for compressing the start data unit START_DU, from among the remaining candidate compression algorithms except for any previously selected candidate compression algorithms.

The controller 120 may select the first compression algorithm CA_1 in a different method from that described above with reference to FIG. 5.

For example, a host may select a specific compression algorithm itself on the basis of the characteristics of data units DU (e.g., the size of the data units DU and the pattern of the data units DU), and may transmit information on the selected compression algorithm to the controller 120. The controller 120 may use the information to select the first compression algorithm CA_1 on the basis of the information on the compression algorithm received from the host.

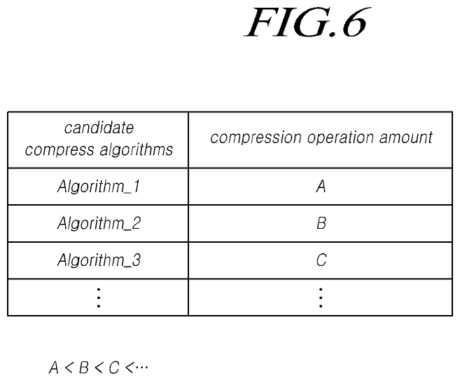

FIG. 6 is a diagram illustrating reference information used by a storage device to arrange the plurality of candidate compression algorithms according to the embodiments of the present disclosure.

For example, a reference information used to arrange a plurality of candidate compression algorithms Algorithm_1, Algorithm_2, Algorithm_3, . . . may be information about the amount of compression in operations of the plurality of candidate compression algorithms Algorithm_1, Algorithm_2, Algorithm_3, . . . .

The information on the compression operation amount of each of the plurality of candidate compression algorithms Algorithm_1, Algorithm_2, Algorithm_3, . . . is independent of the characteristics of input data, and a result of comparing a compression operation amount for each compression algorithm may be determined in advance. Therefore, the plurality of candidate compression algorithms Algorithm_1, Algorithm_2, Algorithm_3, . . . may be arranged before actually compressing the start data unit START_DU.

In FIG. 6, a controller 120 of a storage device 100 may arrange the plurality of candidate compression algorithms Algorithm_1, Algorithm_2, Algorithm_3, . . . in the ascending order of compression operation amounts, which determined in advance.

Among the plurality of candidate compression algorithms Algorithm_1, Algorithm_2, Algorithm_3, . . . , the candidate compression algorithm Algorithm_1, whose compression operation amount is A, becomes a candidate compression algorithm which is selected first; the candidate compression algorithm Algorithm_2, whose compression operation amount is B, becomes a candidate compression algorithm which is selected second; and the candidate compression algorithm Algorithm_3, whose compression operation amount is C, becomes a candidate compression algorithm which is selected third.

An operation in which a storage device 100 compresses an N number of first data units DU_1 using a first compression algorithm has been described above.

In the embodiments of the present disclosure, after compressing the N number of first data units DU_1 using the first compression algorithm, the storage device 100 may compress subsequent data units by selecting a different compression algorithm.

Because the first compression algorithm is determined using only the start data unit START_DU, the first compression algorithm may not be an optimal compression algorithm for the subsequent data units. Therefore, by compressing the subsequent data units using a different compression algorithm, the storage device 100 may prevent an average compression ratio for all the data units from decreasing when a compression algorithm is selected using only some data units.

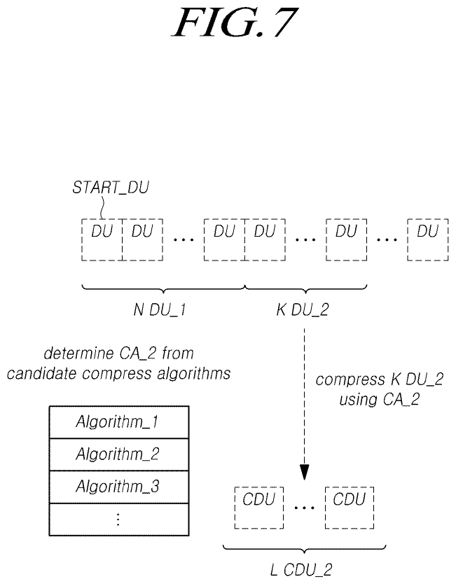

FIG. 7 is a diagram illustrating an operation in which a storage device compresses a K number of second data units DU_2 according to embodiments of the present disclosure.

Referring to FIG. 7, after compressing an N number of first data units DU_1, a controller 120 of a storage device 100 may select a second compression algorithm CA_2 from among a plurality of candidate compression algorithms Algorithm_1, Algorithm_2, Algorithm_3, . . . .

The second compression algorithm CA_2 may be the same as or different from the first compression algorithm CA_1.

Thereafter, the controller 120 may compress K (K is a natural number) number of second data units DU_2, which are input after the N number of first data units DU_1, into an L (where L is a natural number equal to or smaller than K) number of second compressed data units CDU_2 using the second compression algorithm CA_2.

The controller 120 may determine the second compression algorithm CA_2 in the following way.

The controller 120 may include a buffer (not illustrated), which temporarily stores at least one of the plurality of data units DU, and may select the second compression algorithm CA_2 using the data unit DU stored in the buffer.

The controller 120 may store the plurality of data units DU in the buffer in an order in which the plurality of data units DU are input, and then, may delete, from the buffer, a data unit DU that is completely compressed. The data unit DU stored in the buffer may be at least one of the K number of second data units DU_2.

The controller 120 may determine a time point at which the second compression algorithm CA_2 is utilized, as follows.

For example, the controller 120 may determine the second compression algorithm CA_2 during an idle time. The controller 120 does not access the memory 110 during the idle time.

In another example, the controller 120 may determine the second compression algorithm CA_2 when a preset time has elapsed after determining the first compression algorithm CA_1 or when a request that instructs a re-determination of a compression algorithm is received from the host.

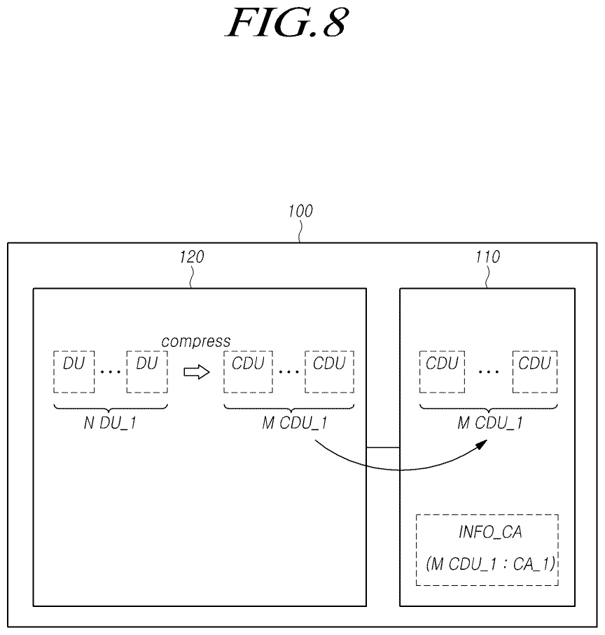

FIG. 8 is a diagram illustrating an operation in which a storage device stores compression algorithm information in a memory according to the embodiments of the present disclosure.

Referring to FIG. 8, a controller 120 of a storage device 100 may additionally store, in a memory 110, compression algorithm information INFO_CA indicating that an M number of first compressed data units CDU_1 are compressed with a first compression algorithm CA_1.

In order to decompress the M number of first compressed data units CDU_1, the controller 120 may use the compression algorithm information INFO_CA indicating which compression algorithm was used to compress the M number of first compressed data units CDU_1.

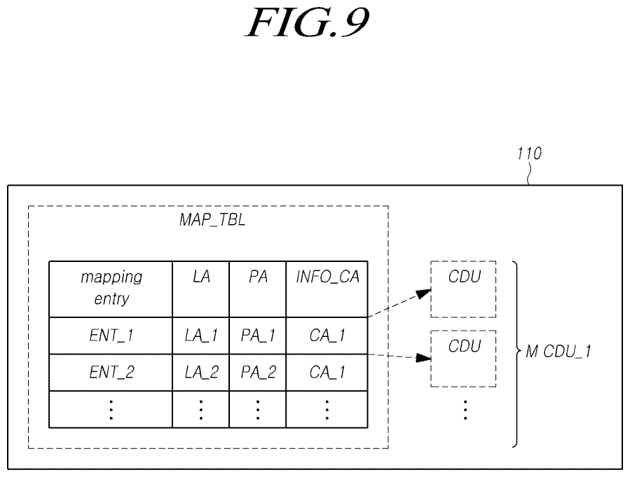

FIG. 9 is a diagram illustrating an operation in which a storage device stores compression algorithm information in a mapping table according to the embodiments of the present disclosure.

Referring to FIG. 9, a memory 110 may store a mapping table MAP_TBL, which includes a plurality of mapping entries ENT_1, ENT_2, . . . . Each of the plurality of mapping entries ENT_1, ENT_2, . . . may indicate mapping information between a logical address LA and a physical address PA.

The controller 120 may store a compression algorithm information INFO_CA in mapping entries corresponding to an M number of first compressed data units CDU_1 among the plurality of mapping entries ENT_1, ENT_2, . . . included in the mapping table MAP_TBL.

In FIG. 9, a field corresponding to the M number of first compressed data units CDU_1 in the mapping table MAP_TBL indicates that the M number of first compressed data units CDU_1 are compressed with a first compression algorithm CA_1.

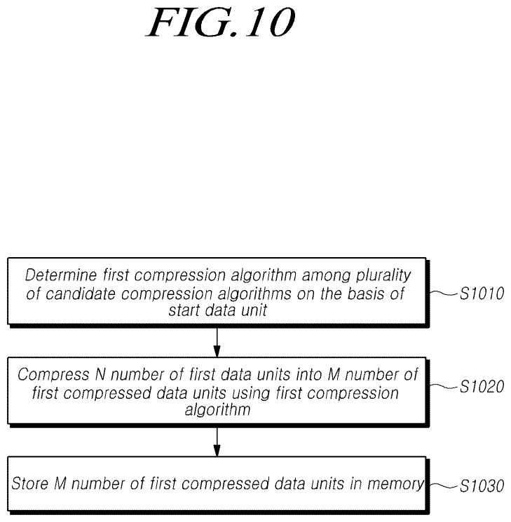

FIG. 10 is a diagram illustrating a method for operating a storage device according to embodiments of the present disclosure.

Referring to FIG. 10, a method for operating a storage device 100 may include step S1010 of determining a first compression algorithm CA_1 among a plurality of candidate compression algorithms using a start data unit START_DU, which is the first data unit input from a host among a plurality of data units DU inputted.

For example, step S1010 may include arranging a plurality of candidate compression algorithms in an order determined according to reference information; selecting a candidate compression algorithm for compressing the start data unit START_DU from among the plurality of candidate compression algorithms; compressing the start data unit START_DU using the selected candidate compression algorithm; and determining the selected candidate compression algorithm as the first compression algorithm CA_1 when a compression ratio for the start data unit START_DU is equal to or greater than a threshold compression ratio and reselecting a candidate compression algorithm for compressing the start data unit START_DU when a compression ratio for the start data unit START_DU is less than the threshold compression ratio.

The reference information may be compression operation amount information for each of the plurality of candidate compression algorithms.

The method for operating the storage device 100 may include step S1020 of compressing an N (N is a natural number) number of first data units DU_1, which are input first from among the plurality of data units DU, into an M (M is a natural number equal to or smaller than N) number of first compressed data units CDU_1 using the first compression algorithm CA_1.

The method for operating the storage device 100 may include step S1030 of storing the M number of first compressed data units CDU_1 in a memory 110.

The method for operating the storage device 100 may further include determining a second compression algorithm CA_2 from among the plurality of candidate compression algorithms after compressing the N number of first data units DU_1; compressing K number of second data units DU_2, which are inputted after the N number of first data units DU_1 among the plurality of data units DU, into L number of second compressed data units CDU_2 using the second compression algorithm CA_2; and storing the L number of second compressed data units CDU_2 in the memory 110.

For example, the step of determining the second compression algorithm CA_2 may determine the second compression algorithm CA_2 using a data unit DU stored in a buffer, which temporarily stores at least one of the plurality of data units DU.

For example, the step of determining the second compression algorithm CA_2 may determine the second compression algorithm CA_2 during an idle time.

For example, the step of determining the second compression algorithm CA_2 may determine the second compression algorithm CA_2 when a preset time has elapsed after determining the first compression algorithm CA_1 or when a request that instructs re-determining a compression algorithm is received from a host.

The method for operating the storage device 100 may further include a step of additionally storing, in the memory 110, compression algorithm information INFO_CA indicating that the M number of first compressed data units CDU_1 are compressed with the first compression algorithm CA_1.

The step of additionally storing the compression algorithm information INFO_CA in the memory 110 may store the compression algorithm information INFO_CA in mapping entries corresponding to the M number of first compressed data units CDU_1 in a mapping table MAP_TBL including a plurality of mapping entries, each of which indicates mapping information between a logical address and a physical address.

Although exemplary embodiments of the disclosure have been described for illustrative purposes, those skilled in the art will appreciate that various modifications, additions and substitutions are possible, without departing from the scope and spirit of the disclosure. Therefore, the embodiments disclosed above and in the accompanying drawings should be considered in a descriptive sense only and not for limiting the technological scope. The technological scope of the disclosure is not limited by the embodiments and the accompanying drawings. The spirit and scope of the disclosure should be interpreted in connection with the appended claims and encompass all equivalents falling within the scope of the appended claims.

What is claimed is:

1. A storage device comprising:
a memory; and
a controller configured to compress a plurality of data units, input from a host, into a plurality of compressed data units and to store the plurality of compressed data units in the memory,
wherein the controller selects a first compression algorithm among a plurality of candidate compression algorithms using a start data unit, which is input first among the plurality of data units,
wherein the controller compresses an N number of first data units, which are input first among the plurality of data units, into an M number of first compressed data units using the first compression algorithm,
wherein the controller stores the M number of first compressed data units in the memory,
wherein N is a natural number, and
wherein M is a natural number equal to or smaller than N.

2. The storage device according to claim 1, wherein the controller
arranges the plurality of candidate compression algorithms in an order that is determined according to a reference information,
selects a candidate compression algorithm for compressing the start data unit from among the plurality of candidate compression algorithms,
compresses the start data unit using the selected candidate compression algorithm,
selects, when a compression ratio for the start data unit is equal to or greater than a threshold compression ratio, the selected candidate compression algorithm as the first compression algorithm, and
reselects, when a compression ratio for the start data unit is less than the threshold compression ratio, a candidate compression algorithm for compressing the start data unit from among the plurality of candidate compression algorithms.

3. The storage device according to claim 2, wherein the reference information comprises compression operation amount information of each of the plurality of candidate compression algorithms.

4. The storage device according to claim 1,
wherein the controller
selects a second compression algorithm from among the plurality of candidate compression algorithms after compressing the N number of first data units using the first compression algorithm,
compresses K number of second data units, which are inputted after the N number of first data units among the plurality of data units, into L number of second compressed data units using the second compression algorithm, and
stores the L number of second compressed data units in the memory,
wherein K is a natural number, and
wherein L is a natural number equal to or smaller than K.

5. The storage device according to claim 4, wherein the controller
includes a buffer that temporarily stores at least one of the plurality of data units, and
selects the second compression algorithm on the basis of a data unit that is stored in the buffer among the plurality of data units.

6. The storage device according to claim 4, wherein the controller selects the second compression algorithm during an idle time.

7. The storage device according to claim 4, wherein the controller selects the second compression algorithm when a preset time has elapsed after selecting the first compression algorithm or when a request is received from a host to reselect a compression algorithm.

8. The storage device according to claim 1, wherein the controller additionally stores, in the memory, compression algorithm information indicating that the M number of first compressed data units are compressed with the first compression algorithm.

9. The storage device according to claim 8, wherein
the memory stores a mapping table including a plurality of mapping entries each of which indicates mapping information between a logical address and a physical address, and
the controller stores the compression algorithm information in mapping entries corresponding to the M number of first compressed data units among the plurality of mapping entries.

10. A method for operating a storage device, comprising:
determining a first compression algorithm among a plurality of candidate compression algorithms on the basis of a start data unit, which is inputted first among a plurality of data units inputted from a host;
compressing N number of first data units, which are inputted first among the plurality of data units, into M number of first compressed data units using the first compression algorithm; and
storing the M number of first compressed data units in a memory,
wherein N is a natural number, and
wherein M is a natural number equal to or smaller than N.

11. The method according to claim 10, wherein the determining a first compression algorithm comprises:
arranging the plurality of candidate compression algorithms in an order determined according to a reference information;
selecting a candidate compression algorithm for compressing the start data unit among the plurality of candidate compression algorithms;
compressing the start data unit using the selected candidate compression algorithm; and
determining the selected candidate compression algorithm as the first compression algorithm when a compression ratio for the start data unit is equal to or greater than a threshold compression ratio, and re-determining a candidate compression algorithm for compressing the start data unit among the plurality of candidate compression algorithms when a compression ratio for the start data unit is less than the threshold compression ratio.

12. The method according to claim 11, wherein the reference information is compression operation amount information of the plurality of candidate compression algorithms.

13. The method according to claim 10, further comprising:
determining a second compression algorithm among the plurality of candidate compression algorithms after compressing the N number of first data units;
compressing K number of second data units, which are inputted after the N number of first data units among the plurality of data units, into L number of second compressed data units using the second compression algorithm; and
storing the L number of second compressed data units in the memory,
wherein K is a natural number, and
wherein L is a natural number equal to or smaller than K.

14. The method according to claim 13, wherein the determining a second compression algorithm determines the second compression algorithm on the basis of a data unit stored in a buffer which temporarily stores at least one of the K number of second data units.

15. The method according to claim 13, wherein the determining a second compression algorithm determines the second compression algorithm during an idle time.

16. The method according to claim 13, wherein the determining a second compression algorithm determines the second compression algorithm when a preset time has elapsed after determining the first compression algorithm or when a request which instructs to re-determine a compression algorithm is received from the host.

17. The method according to claim 10, further comprising:
additionally storing, in the memory, compression algorithm information indicating that the M number of first compressed data units are compressed with the first compression algorithm.

18. The method according to claim 17, wherein the additionally storing, in the memory, compression algorithm information stores the compression algorithm information in mapping entries corresponding to the M number of first compressed data units in a mapping table including a plurality of mapping entries each of which indicates mapping information between a logical address and a physical address.

19. A storage device comprising:
a memory; and
a controller configured to compress a plurality of data units input from a host into a plurality of compressed data units using at least one of a plurality of candidate compression algorithms, and to store the plurality of compressed data units in the memory,
wherein an M number of first data units among the plurality of data units are compressed using a first compression algorithm among the plurality of candidate compression algorithms,
wherein an N number of second data units among the plurality of data units are compressed using a second compression algorithm among the plurality of candidate compression algorithms, and
wherein M and N are natural numbers.
